(19) United States
(12) Patent Application Publication
(10) Pub. No.: US 2019/0014773 A1
(43) Pub. Date: Jan. 17, 2019

(54) RAMP-EQUIPPED BOX BLIND STAND

(71) Applicant: Stephen Lamb, Logan, OH (US)

(72) Inventor: Stephen Lamb, Logan, OH (US)

(21) Appl. No.: 15/648,958

(22) Filed: Jul. 13, 2017

(51) Int. Cl. A01M 31/02; E04H 15/00; E06C 1/39

(52) U.S. Cl. CPC A01M 31/02; E06C 1/39; E04H 15/001

(57) ABSTRACT

A ramp-equipped box blind stand for ease of access includes a platform that is configured to position on a surface, such as in a field for hunting. A first ramp is coupled to a top of the platform and extends angularly from the platform to the surface. A carriage is slidably coupled to the first ramp and is selectively positionable along the first ramp. The carriage extends transversely from the first ramp so that it is substantially parallel to the surface. The carriage is configured to position a load, such as a box blind and an occupied wheelchair. A lift is operationally coupled to the carriage and the first ramp. The lift is configured to motivate the carriage along the first ramp to transfer the load between the surface and the top of the platform. A pair of first railings that is coupled the first ramp is configured to prevent falls.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

[symbol]

### (2) Description of Related Art Including Information Disclosed Under 37 CFR 1.97 and 1.98.

The disclosure and prior art relates to box blind stands and more particularly pertains to a new box blind stand for ease of access.

### BRIEF SUMMARY OF THE INVENTION

An embodiment of the disclosure meets the needs presented above by generally comprising a platform that is configured to position on a surface, such as in a field for hunting. A first ramp is coupled to a top of the platform and extends angularly from the platform to the surface. A carriage is slidably coupled to the first ramp and is selectively positionable along the first ramp. The carriage extends transversely from the first ramp so that it is substantially parallel to the surface. The carriage is configured to position a load, such as a box blind and an occupied wheelchair. A lift is operationally coupled to the carriage and the first ramp. The lift is configured to motivate the carriage along the first ramp to transfer the load between the surface and the top of the platform. A pair of first railings that is coupled the first ramp is configured to prevent falls.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a ramp-equipped box blind stand according to an embodiment of the disclosure.

FIG. 2 is an in-use view of an embodiment of the disclosure.

FIG. 3 is a detail view of an embodiment of the disclosure.

FIG. 4 is a detail view of an embodiment of the disclosure.

FIG. 5 is a cross-sectional view of an embodiment of the disclosure.

FIG. 6 is a detail view of an embodiment of the disclosure.

### DETAILED DESCRIPTION OF THE INVENTION

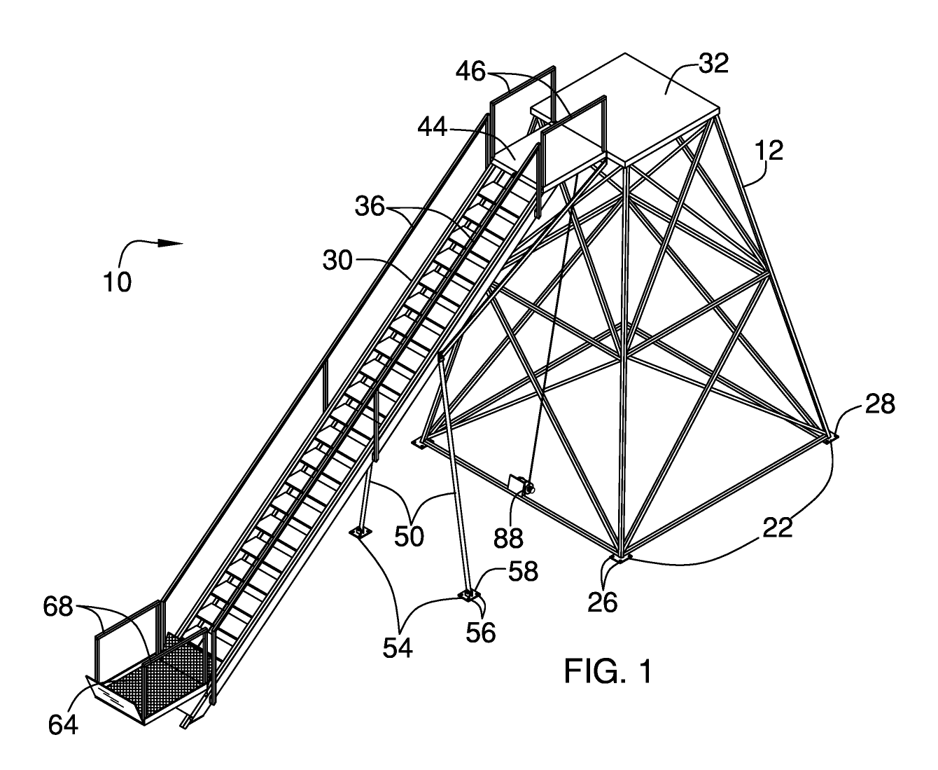

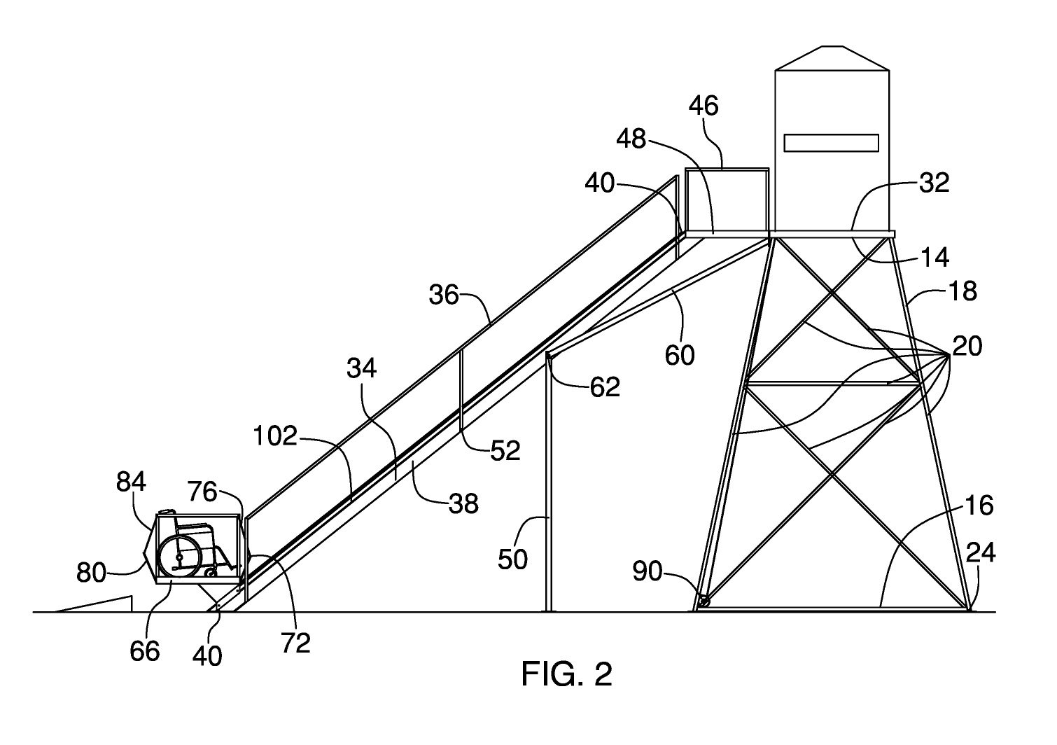

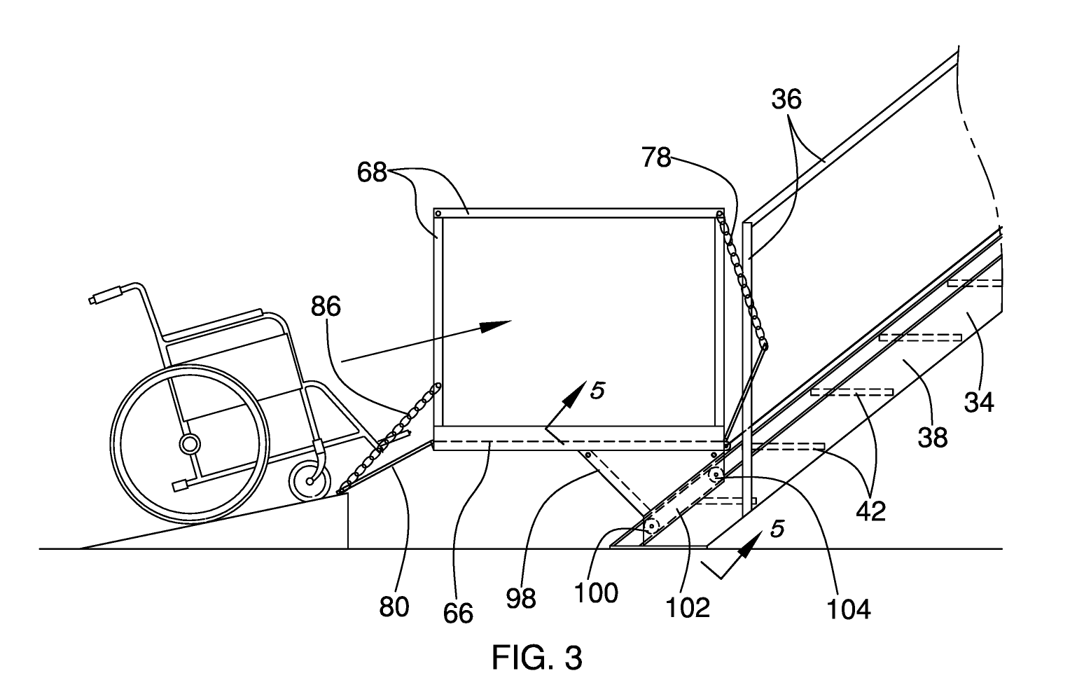

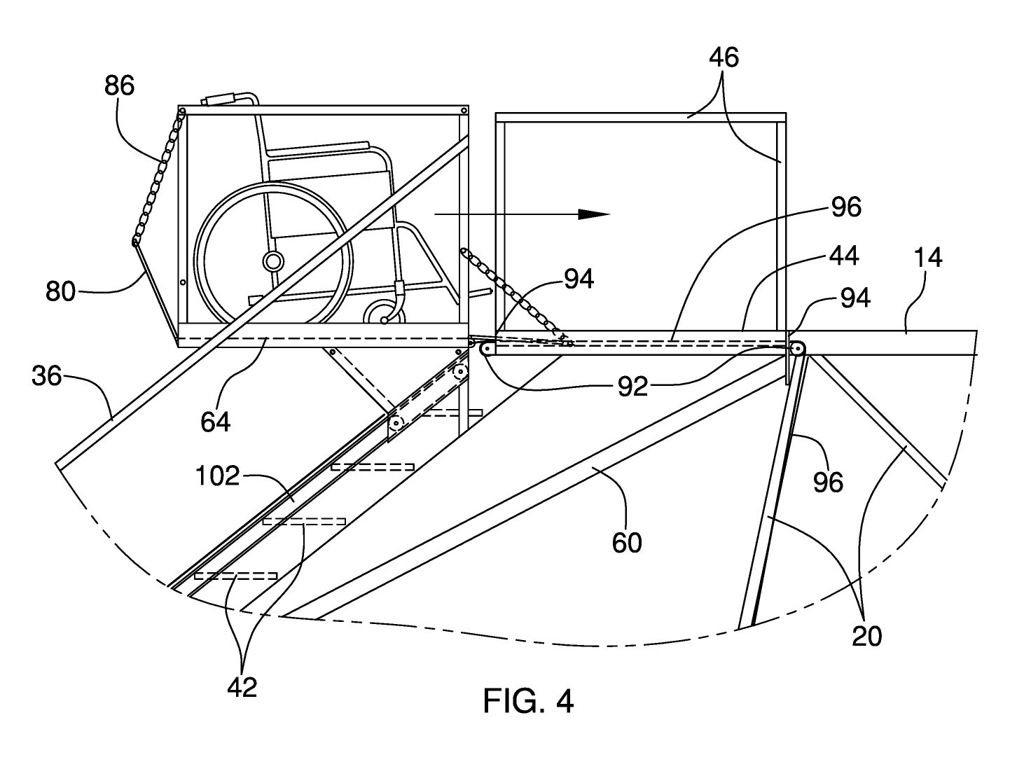

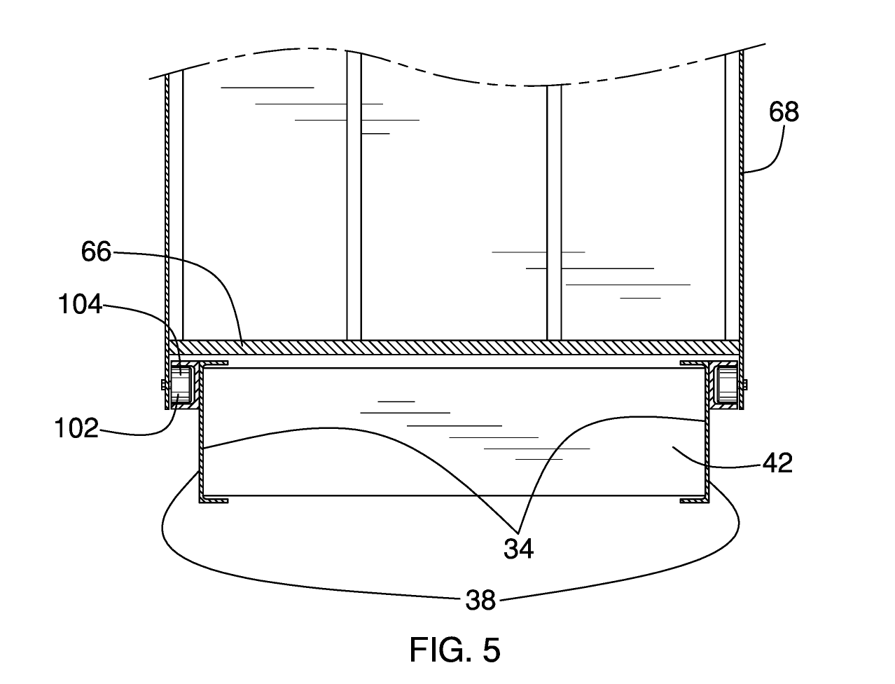

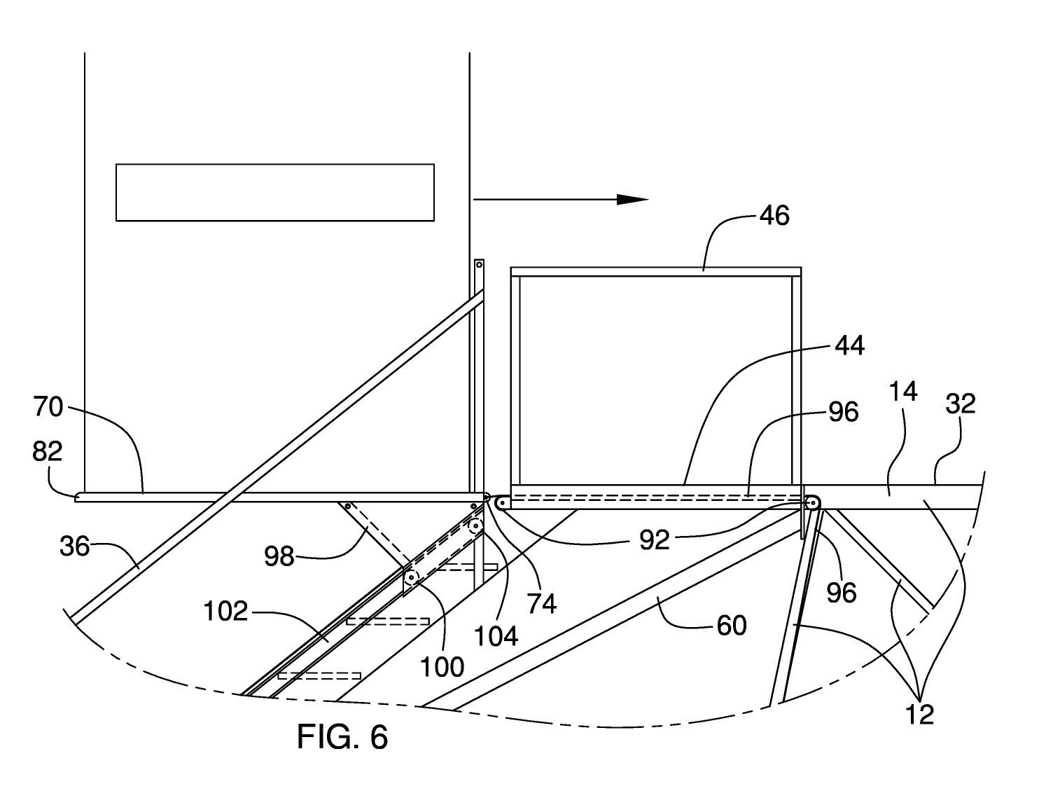

With reference now to the drawings, and in particular to FIGS. 1 through 6 thereof, a new box blind stand embodying the principles and concepts of an embodiment of the disclosure and generally designated by the reference numeral 10 will be described.

As best illustrated in FIGS. 1 through 6, the ramp-equipped box blind stand 10 generally comprises a platform 12 that is configured to position on a surface, such as in a field for hunting. The platform 12 is configured to position a box blind. The platform 12 comprises a top plate 14, a base 16, and a frame 18. The frame 18 is coupled to and extends between the top plate 14 and the base 16. The top plate 14 is positioned substantially parallel to the surface when the frame 18 is upright. In one embodiment, the top plate 14 and the base 16 are squarely shaped. The base 16 is dimensionally larger than the top plate 14 so that the frame 18 is right frustum shaped. In another embodiment, the base 16 and the frame 18 comprises a plurality of interconnected rods 20 so that the frame 18 and the base 16 are open-framed.

A plurality of first connectors 22 is coupled to the base 16. The first connectors 22 are configured to couple to the surface to couple the platform 12 to the surface. In one embodiment, the plurality of first connectors 22 comprises four first connectors 22 that are positioned singly at each corner 24 of the base 16. In another embodiment, each first connector 22 comprises a set of first holes 26 that is positioned through a first panel 28. The first panel 28 is rigid. Each first hole 26 is configured to insert hardware, such as a spike, to couple the platform 12 to the surface.

A first ramp 30 is coupled to a top 32 of the platform 12 and extends angularly from the platform 12 to the surface. In one embodiment, the first ramp 30 comprises a pair of beams 34.

Each of a pair of first railings 36 is coupled to and extends upwardly from a respective opposing side 38 of the first ramp 30. The first railings 36 extend between opposing termini 40 of the first ramp 30. The first railings 36 are configured to prevent falls from the first ramp 30 to the surface.

Each of a pair of channels 102 is positioned in a respective opposing side 38 of the first ramp 30. The channels 102 extend between the opposing termini 40 of the first ramp 30.

A plurality of slats 42 is coupled to and extends between the beams 34. The slats 42 are positioned substantially parallel to the surface. The slats 42 are configured for a user to walk up and down the first ramp 30.

A landing plate 44 is coupled to and is positioned between the top plate 14 and the first ramp 30. The landing plate 44 extends coplanarly from the top plate 14. The first ramp 30 extends from the landing plate 44 distal from the top plate 14.

Each of a pair of second railings 46 is coupled to and extends upwardly from a respective opposing edge 48 of the landing plate 44. The second railings 46 are configured to prevent falls from the landing plate 44 to the surface.

Each of a pair of first rods 50 is pivotally coupled to and extends transversely from the first ramp 30 to the surface. The first rods 50 are positioned singly on the opposing sides 38 of the ramp between a midpoint 52 of the first ramp 30 and the landing plate 44. The first rods 50 are configured to deter deflection of the first ramp 30.

A pair of second connectors 54 is coupled singly to the first rods 50 distal from the first ramp 30. The second connectors 54 are configured to couple to the surface to couple the first rods 50 to the surface. In one embodiment, each second connector 54 comprises a set of second holes 56 that positioned through a second panel 58. The second panel 58 is rigid. Each second hole 56 is configured to insert hardware, such as a spike, to couple the first rods 50 to the surface.

Each of a pair of second rods 60 is coupled to and extends between the top 32 of the platform 12 and an intersection 62 of a respective first rod 50 and the first ramp 30.

A carriage 64 is slidably coupled to the first ramp 30. The carriage 64 is selectively positionable along the first ramp 30. The carriage 64 extends transversely from the first ramp 30 so that the carriage 64 is substantially parallel to the surface. The carriage 64 is configured to position a load, such as the box blind and an occupied wheelchair. In one embodiment, each carriage 64 comprises a bottom plate 66 and a pair of third railings 68. Each third railing 68 is coupled to and extends upwardly from a respective opposing rim 70 of the bottom plate 66. In another embodiment, the bottom plate 66 is textured.

A second ramp 72 hingedly is coupled to a first edge 74 of the bottom plate 66. The second ramp 72 is configured to be selectively positioned in a deployed configuration and a retracted configuration. In the deployed configuration, the second ramp 72 extends substantially coplanarly from the bottom plate 66 and is configured to transition the load between the bottom plate 66 and the landing plate 44. In the retracted configuration, the second ramp 72 extends upwardly from the bottom plate 66 to retain the load on the bottom plate 66.

At least on first coupler 76 is coupled to the second ramp 72. The at least on first coupler 76 is configured to couple to the carriage 64 to retain the second ramp 72 in the retracted configuration. In one embodiment, the at least on first coupler 76 comprises a first chain 78.

A third ramp 80 is hingedly coupled to a second edge 82 of the bottom plate 66. The third ramp 80 is configured to be selectively positioned in a deployed configuration and a retracted configuration. In the deployed configuration, the third ramp 80 extends from the bottom plate 66 to the surface and is configured to transition the load between the surface and the bottom plate 66. In the retracted configuration, the third ramp 80 extends upwardly from the bottom plate 66 to retain the load on the bottom plate 66.

At least one second coupler 84 is coupled to the third ramp 80. The at least on second coupler 84 is configured to couple to the carriage 64 to retain the third ramp 80 in the retracted configuration. In one embodiment, the at least on second coupler 84 comprises a second chain 86.

A lift 88 is operationally coupled to the carriage 64 and the first ramp 30. The lift 88 is configured to motivate the carriage 64 along the first ramp 30 so that the load is transferrable between the surface and the top 32 of the platform 12. In one embodiment, the lift 88 comprises a winch 90 that is coupled to the base 16 of the platform 12. The winch 90 is configured to couple to a source of alternating current, such as a battery.

Each of a pair of pulleys 92 are coupled singly to opposing ends 94 of the landing plate 44. The pulleys 92 are positioned equally distant from the opposing edges 48 of the landing plate 44. A cable 96 is coupled to and extends between the carriage 64 and the winch 90. The cable 96 is operationally coupled to the winch 90 and the pair of pulleys 92.

Each of a pair of bars 98 is coupled singly to and extends transversely from the opposing rims 70 of the bottom plate 66. The bars 98 are substantially perpendicular to the first ramp 30. The bars 98 are positioned substantially equally distant from the first edge 74 and the second edge 82 of the bottom plate 66.

Each of a pair of rear rollers 100 is axially coupled to a respective bar 98 distal from the bottom plate 66. Each rear roller 100 is positioned in a respective channel 102. Each of a pair of front rollers 104 is axially coupled to a respective opposing rim 70 of the bottom plate 66 proximate to the first edge 74. Each front roller 104 is positioned in a respective channel 102. The winch 90 is positioned to retract the cable 96 to motivate the front rollers 104 and the rear rollers 100 within the pair of channels 102 to motivate the carriage 64 upwardly along the first ramp 30 to the landing plate 44. The winch 90 also is positioned to extend the cable 96 to lower the carriage 64 along the ramp to the surface.

In use, the first connectors 22 are configured to couple the platform 12 to the surface, such as in the field for hunting. The first rods 50 are configured to deter deflection of the first ramp 30. The second connectors 54 are configured to couple the first rods 50 to the surface. The slats 42 are configured for the user to walk up and down the first ramp 30. The second ramp 72 is configured to be selectively positioned in the retracted configuration so that the second ramp 72 extends upwardly from the bottom plate 66 to retain the load on the bottom plate 66. The third ramp 80 is configured to be selectively positioned in the deployed configuration. The third ramp 80 extends from the bottom plate 66 to the surface and is configured to transition the load between the surface and the bottom plate 66. The carriage 64 is configured to position the load, such as the box blind and the occupied wheelchair. The third ramp 80 is configured to be selectively positioned in the retracted configuration, wherein the third ramp 80 extends upwardly from the bottom plate 66, to retain the load on the bottom plate 66. The winch 90 is positioned to retract the cable 96 to motivate the front rollers 104 and the rear rollers 100 within the pair of channels 102 to motivate the carriage 64 upwardly along the first ramp 30 to the landing plate 44. The first railings 36 that are positioned on the first ramp 30 are configured to prevent falls from the first ramp 30 to the surface. The second ramp 72 is configured to be selectively positioned in the deployed configuration so that second ramp 72 extends substantially coplanarly from the bottom plate 66 and is configured to transition the load between the bottom plate 66 and the landing plate 44. The second railings 46 that are positioned on the landing plate 44 are configured to prevent falls from the landing plate 44 to the surface. The winch 90 also is positioned to extend the cable 96 to lower the carriage 64 along the ramp to the surface.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A ramp-equipped box blind stand comprising:
a platform configured for positioning on a surface, such as in a field for hunting, said platform being configured for positioning a box blind;
a first ramp coupled to a top of said platform and extending angularly from said platform to the surface;
a pair of first railings, each said first railing being coupled to and extending upwardly from a respective opposing side of said first ramp, said first railings extending between opposing termini of said first ramp;
a carriage slidably coupled to said first ramp such that said carriage is selectively positionable along said first ramp, said carriage extending transversely from said first ramp such that said carriage is substantially parallel to the surface;
a lift operationally coupled to said carriage and said first ramp; and
wherein said first railings are positioned on said first ramp such that said first railings are configured for preventing falls from said first ramp to the surface, wherein said carriage is positioned on said first ramp such that said carriage is configured for positioning a load, such as the box blind and an occupied wheelchair, wherein said lift is positioned on said carriage and said first ramp such that said lift is configured for motivating said carriage along said first ramp such that the load is transferrable between the surface and said top of said platform.

2. The stand of claim 1, further including said platform comprising a top plate, a base, and a frame, said frame being coupled to and extending between said top plate and said base such that said top plate is positioned substantially parallel to the surface when said frame is upright.

3. The stand of claim 2, further including said top plate and said base being squarely shaped, said base being dimensionally larger than said top plate such that said frame is right frustum shaped.

4. The stand of claim 2, further including said base and said frame comprising a plurality of interconnected rods such that said frame and said base are open-framed.

5. The stand of claim 2, further including a plurality of first connectors coupled to said base, said first connectors being configured for coupling to the surface, wherein said first connectors are positioned on said base such that said first connectors are configured for coupling said platform to the surface, said plurality of first connectors comprising four said first connectors positioned singly at each corner of said base.

6. The stand of claim 5, further including each said first connector comprising a set of first holes positioned through a first panel, said first panel being rigid, wherein said first holes are positioned through said first panel such that each said first hole is configured for inserting hardware, such as a spike, for coupling said platform to the surface.

7. The stand of claim 1, further comprising:
said first ramp comprising a pair of beams;
a plurality of slats coupled to and extending between said beams; and
wherein said slats are positioned on said beams such that said slats are positioned substantially parallel to the surface, wherein said slats are configured for walking up and down said first ramp.

8. The stand of claim 2, further including a landing plate coupled to and positioned between said top plate and said first ramp, said landing plate extending coplanarly from said top plate, said first ramp extending from said landing plate distal from said top plate.

9. The stand of claim 8, further including a pair of second railings, each said second railing being coupled to and extending upwardly from a respective opposing edge of said landing plate, wherein said second railings are positioned on said landing plate such that said second railings are configured for preventing falls from said landing plate to the surface.

10. The stand of claim 8, further comprising:
a pair of first rods pivotally coupled to and extending transversely from said first ramp to the surface, said first rods being positioned singly on said opposing sides of said ramp between a midpoint of said first ramp and said landing plate;
a pair of second connectors coupled singly to said first rods distal from said first ramp, said second connectors being configured for coupling to the surface;
a pair of second rods, each said second rod being coupled to and extending between said top of said platform and an intersection of a respective said first rod and said first ramp; and
wherein said first rods are positioned between said first ramp and the surface such that said first rods are configured for deterring deflection of said first ramp, wherein said second connectors are positioned on said first rods such that said second connectors are configured for coupling said first rods to the surface.

11. The stand of claim 10, further including each said second connector comprising a set of second holes positioned through a second panel, said second panel being rigid, wherein said second holes are positioned through said second panel such that each said second hole is configured for inserting hardware, such as a spike, for coupling said first rods to the surface.

12. The stand of claim 8, further including said carriage comprising a bottom plate and a pair of third railings, each said third railing being coupled to and extending upwardly from a respective opposing rim of said bottom plate.

13. The stand of claim 12, further including said bottom plate being textured.

14. The stand of claim 12, further comprising:
a second ramp hingedly coupled to a first edge of said bottom plate;
at least on first coupler coupled to said second ramp, said at least on first coupler being configured for coupling to said carriage for retaining said second ramp in the retracted configuration;
a third ramp hingedly coupled to a second edge of said bottom plate;
at least one second coupler coupled to said third ramp, said at least on second coupler being configured for coupling to said carriage for retaining said third ramp in the retracted configuration; and
wherein said second ramp is configured for selectively positioning in a deployed configuration, wherein said second ramp extends substantially coplanarly from said bottom plate and is configured for transitioning the load between said bottom plate and said landing plate, and a retracted configuration wherein said second ramp extends upwardly from said bottom plate for retaining the load on said bottom plate, wherein said third ramp is configured for selectively positioning in a deployed configuration, wherein said third ramp extends from said bottom plate to the surface and is configured for transitioning the load between the surface and said bottom plate, and a retracted configuration, wherein said third ramp extends upwardly from said bottom plate for retaining the load on said bottom plate.

15. The stand of claim 14, further including said at least on first coupler comprising a first chain, said at least on second coupler comprising a second chain.

16. The stand of claim 12, further comprising:
a pair of channels, each said channel being positioned in a respective said opposing side of said first ramp, said channels extending between said opposing termini of said first ramp;
said lift comprising:
a winch coupled to said base of said platform, said winch being configured for coupling to a source of alternating current, such as a battery,
a pair of pulleys coupled singly to opposing ends of said landing plate, said pulleys being positioned equally distant from said opposing edges of said landing plate,
a cable coupled to and extending between said carriage and said winch, said cable being operationally coupled to said winch and said pair of pulleys,
a pair of bars coupled singly to and extending transversely from said opposing rims of said bottom plate such that said bars are substantially perpendicular to said first ramp, said bars being positioned substantially equally distant from said first edge and said second edge,
a pair of rear rollers, each said rear roller being axially coupled to a respective said bar distal from said bottom plate, each said rear roller being positioned in a respective said channel, and
a pair of front rollers, each said front roller being axially coupled to a respective said opposing rim of said bottom plate proximate to said first edge, each said front roller being positioned in a respective said channel; and
wherein said winch is positioned on said platform such that said winch is positioned for retracting said cable for motivating said front rollers and said rear rollers within said pair of channels for motivating said carriage upwardly along said first ramp to said landing plate, and wherein said winch is positioned for extending said cable for lowering said carriage along said ramp to the surface.

17. A ramp-equipped box blind stand comprising:
a platform configured for positioning on a surface, such as in a field for hunting, said platform being configured for positioning a box blind, said platform comprising a top plate, a base, and a frame, said frame being coupled to and extending between said top plate and said base such that said top plate is positioned substantially parallel to the surface when said frame is upright, said top plate and said base being squarely shaped, said base being dimensionally larger than said top plate such that said frame is right frustum shaped, said base and said frame comprising a plurality of interconnected rods such that said frame and said base are open-framed;
a plurality of first connectors coupled to said base, said first connectors being configured for coupling to the surface, wherein said first connectors are positioned on said base such that said first connectors are configured for coupling said platform to the surface, said plurality of first connectors comprising four said first connectors positioned singly at each corner of said base, each said first connector comprising a set of first holes positioned through a first panel, said first panel being rigid, wherein said first holes are positioned through said first panel such that each said first hole is configured for inserting hardware, such as a spike, for coupling said platform to the surface;
a first ramp coupled to a top of said platform and extending angularly from said platform to the surface, said first ramp comprising a pair of beams;
a pair of first railings, each said first railing being coupled to and extending upwardly from a respective opposing side of said first ramp, said first railings extending between opposing termini of said first ramp, wherein said first railings are positioned on said first ramp such that said first railings are configured for preventing falls from said first ramp to the surface;
a pair of channels, each said channel being positioned in a respective said opposing side of said first ramp, said channels extending between said opposing termini of said first ramp;
a plurality of slats coupled to and extending between said beams, wherein said slats are positioned on said beams such that said slats are positioned substantially parallel to the surface, wherein said slats are configured for walking up and down said first ramp;
a landing plate coupled to and positioned between said top plate and said first ramp, said landing plate extending coplanarly from said top plate, said first ramp extending from said landing plate distal from said top plate;
a pair of second railings, each said second railing being coupled to and extending upwardly from a respective opposing edge of said landing plate, wherein said second railings are positioned on said landing plate such that said second railings are configured for preventing falls from said landing plate to the surface;
a pair of first rods pivotally coupled to and extending transversely from said first ramp to the surface, said first rods being positioned singly on said opposing sides of said ramp between a midpoint of said first ramp and said landing plate, wherein said first rods are positioned between said first ramp and the surface such that said first rods are configured for deterring deflection of said first ramp;
a pair of second connectors coupled singly to said first rods distal from said first ramp, said second connectors being configured for coupling to the surface, wherein said second connectors are positioned on said first rods such that said second connectors are configured for coupling said first rods to the surface, each said second connector comprising a set of second holes positioned through a second panel, said second panel being rigid, wherein said second holes are positioned through said second panel such that each said second hole is configured for inserting hardware, such as a spike, for coupling said first rods to the surface;
a pair of second rods, each said second rod being coupled to and extending between said top of said platform and an intersection of a respective said first rod and said first ramp;
a carriage slidably coupled to said first ramp such that said carriage is selectively positionable along said first ramp, said carriage extending transversely from said first ramp such that said carriage is substantially parallel to the surface, wherein said carriage is positioned on said first ramp such that said carriage is configured for positioning a load, such as the box blind and an occupied wheelchair, said carriage comprising a bottom plate and a pair of third railings, each said third railing being coupled to and extending upwardly from a respective opposing rim of said bottom plate, said bottom plate being textured;
a second ramp hingedly coupled to a first edge of said bottom plate such that said second ramp is configured for selectively positioning in a deployed configuration, wherein said second ramp is configured for selectively positioning in a deployed configuration, wherein said second ramp extends substantially coplanarly from said bottom plate and is configured for transitioning the load between said bottom plate and said landing plate, and a retracted configuration wherein said second ramp extends upwardly from said bottom plate for retaining the load on said bottom plate;
at least on first coupler coupled to said second ramp, said at least on first coupler being configured for coupling to said carriage for retaining said second ramp in the retracted configuration, said at least on first coupler comprising a first chain;
a third ramp hingedly coupled to a second edge of said bottom plate such that said third ramp is configured for selectively positioning in a deployed configuration, wherein said third ramp is configured for selectively positioning in a deployed configuration, wherein said third ramp extends from said bottom plate to the surface and is configured for transitioning the load between the surface and said bottom plate, and a retracted configuration, wherein said third ramp extends upwardly from said bottom plate for retaining the load on said bottom plate;
at least one second coupler coupled to said third ramp, said at least on second coupler being configured for coupling to said carriage for retaining said third ramp in the retracted configuration, said at least on second coupler comprising a second chain;
a lift operationally coupled to said carriage and said first ramp, wherein said lift is positioned on said carriage and said first ramp such that said lift is configured for motivating said carriage along said first ramp such that the load is transferrable between the surface and said top of said platform, said lift comprising:
a winch coupled to said base of said platform, said winch being configured for coupling to a source of alternating current, such as a battery,
a pair of pulleys coupled singly to opposing ends of said landing plate, said pulleys being positioned equally distant from said opposing edges of said landing plate,
a cable coupled to and extending between said carriage and said winch, said cable being operationally coupled to said winch and said pair of pulleys,
a pair of bars coupled singly to and extending transversely from said opposing rims of said bottom plate such that said bars are substantially perpendicular to said first ramp, said bars being positioned substantially equally distant from said first edge and said second edge,
a pair of rear rollers, each said rear roller being axially coupled to a respective said bar distal from said bottom plate, each said rear roller being positioned in a respective said channel,
a pair of front rollers, each said front roller being axially coupled to a respective said opposing rim of said bottom plate proximate to said first edge, each said front roller being positioned in a respective said channel, and
wherein said winch is positioned on said platform such that said winch is positioned for retracting said cable for motivating said front rollers and said rear rollers within said pair of channels for motivating said carriage upwardly along said first ramp to said landing plate, and wherein said winch is positioned for extending said cable for lowering said carriage along said ramp to the surface; and
wherein said first connectors are positioned on said base such that said first connectors are configured for coupling said platform to the surface, such as in the field for hunting, wherein said first rods are positioned between said first ramp and the surface such that said first rods are configured for deterring deflection of said first ramp, wherein said second connectors are positioned on said first rods such that said second connectors are configured for coupling said first rods to the surface, wherein said slats are positioned on said beams such that said slats are configured for walking up and down said first ramp, wherein said second ramp is configured for selectively positioning in the retracted configuration such that said second ramp extends upwardly from said bottom plate for retaining the load on said bottom plate, wherein said third ramp is configured for selectively positioning in the deployed configuration such that said third ramp extends from said bottom plate to the surface and is configured for transitioning the load between the surface and said bottom plate such that said carriage is configured for positioning the load, such as the box blind and the occupied wheelchair, wherein said third ramp is configured for selectively positioning in the retracted configuration such that said third ramp extends upwardly from said bottom plate for retaining the load on said bottom plate, wherein said winch is positioned on said platform such that said winch is positioned for retracting said cable for motivating said front rollers and said rear rollers within said pair of channels for motivating said carriage upwardly along said first ramp to said landing plate, wherein said first railings are positioned on said first ramp such that said first railings are configured for preventing falls from said first ramp to the surface, wherein said second railings are positioned on said landing plate such that said second railings are configured for preventing falls from said landing plate to the surface, wherein said second ramp is configured for selectively positioning in the deployed configuration such that said second ramp extends substantially coplanarly from said bottom plate and is configured for transitioning the load between said bottom plate and said landing plate, and wherein said winch is positioned for extending said cable for lowering said carriage along said ramp to the surface.
